(19) United States
(12) Patent Application Publication
(10) Pub. No.: US 2025/0181157 A1
(43) Pub. Date: Jun. 5, 2025

(54) METHOD AND DEVICE FOR DETERMINING CONTENT TO INSTRUCT AR DEVICE TO DISPLAY

(71) Applicant: Samsung Electronics Co., Ltd., Suwon-si (KR)

(72) Inventors: Jeoungju KIM, Suwon-si (KR); Hyunwoo KIM, Suwon-si (KR); Chanmin PARK, Suwon-si (KR); Sangwon CHAE, Suwon-si (KR); Sunpil HWANG, Suwon-si (KR); Jinmo KANG, Suwon-si (KR); Sungoh KIM, Suwon-si (KR); Jihyun KIM, Suwon-si (KR); Donghyun YEOM, Suwon-si (KR); Gunhee LEE, Suwon-si (KR)

(21) Appl. No.: 19/043,803

(22) Filed: Feb. 3, 2025

Related U.S. Application Data
(63) Continuation of application No. PCT/KR2023/008175, filed on Jun. 14, 2023.

(30) Foreign Application Priority Data
Aug. 8, 2022 (KR) 10-2022-0098762
Sep. 16, 2022 (KR) 10-2022-0117409

(51) Int. Cl. G06F 3/01; G06T 11/00

(52) U.S. Cl. CPC G06F 3/013; G06T 11/00

(57) ABSTRACT

An electronic device is provided. The electronic device includes a memory storing one or more computer programs, and one or more processors communicatively coupled to the memory, wherein the one or more computer programs include computer-executable instructions that, when executed by the one or more processors individually or collectively, cause the electronic device to detect an object in an image received from an augmented reality (AR) device. The instructions may be configured to acquire, on the basis of the location of a user and a user identifier received from the AR device, an interaction history of interactions, between the user and the detected object, for acquiring information about the detected object. The instructions may be configured to instruct the AR device to display, on the basis of the acquired interaction history, a piece of content selected from among a plurality of pieces of content about the object.

### CROSS-REFERENCE TO RELATED APPLICATION(S)

This application is a continuation application, claiming priority under § 365 (c), of an International application No. PCT/KR2023/008175, filed on Jun. 14, 2023, which is based on and claims the benefit of a Korean patent application number 10-2022-0098762, filed on Aug. 8, 2022, in the Korean Intellectual Property Office, and of a Korean patent application number 10-2022-0117409, filed on Sep. 16, 2022 in the Korean Intellectual Property Office, the disclosure of each of which is incorporated by reference herein in its entirety.

### BACKGROUND

### 1. Field

The disclosure relates to a technology for determining a piece of content to instruct an augmented reality (AR) device to display.

### 2. Description of Related Art

Recently, with a sudden growth of electronic devices such as smartphones or tablet personal computers (PCs), the electronic devices enabling wireless voice calls and information exchange have become necessities of life. Electronic devices were initially recognized as simply portable devices for wireless calls. However, with the development of technology and the introduction of the wireless Internet, electronic devices are not simply portable devices for wireless calls but are developed into multimedia devices for performing functions such as scheduling, gaming, remote control, or image capturing, satisfying user demands.

In particular, in recent years, an electronic device providing an augmented reality (AR) service has been introduced to the market. An AR service is a service of superimposing a virtual image having supplementary information on a real-world image seen by a user and showing the superimposition result, and may provide a user with a virtual object image including content related to a real object identified from the real-world image.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a technology for determining a piece of content to instruct an augmented reality (AR) device to display.

Additional aspects will be set forth in part in the description which follows and, in part, will be apparent from the description, or may be learned by practice of the presented embodiments.

In accordance with an aspect of the disclosure, an electronic device is provided. The electronic device includes memory storing one or more computer programs and one or more processors communicatively coupled to the memory, wherein the one or more computer programs include computer-executable instructions that, when executed by the one or more processors individually or collectively, cause the electronic device to detect an object in an image received from an augmented reality (AR) device, obtain, based on the identifier of the user and the position of the user received from the AR device, an interaction history for the interaction between the user and the object to obtain information about the detected object, instruct, based on the obtained interaction history, the AR device to display a piece of content selected from a plurality of pieces of content on the object.

In accordance with another aspect of the disclosure, a method performed by an electronic device is provided. The method includes detecting, by the electronic device, an object in an image received from an AR device, obtaining, by the electronic device, based on the received identifier of the user and a position of the user, an interaction history for the interaction between the user and the object to obtain information about the detected object, instructing, by the electronic device, based on the obtained interaction history, the AR device to display a selected piece of content from among a plurality of pieces of content on the object.

In accordance with an aspect of the disclosure, one or more non-transitory computer-readable storage media storing one or more computer programs including computer-executable instructions that, when executed by one or more processors of an electronic device individually or collectively, cause the electronic device to perform operations are provided. The operations including detecting, by the electronic device, an object in an image received from an augmented reality (AR) device, obtaining, by the electronic device, based on an identifier of a user and a position of the user received from the AR device, an interaction history for an interaction between the user and the detected object to obtain information about the detected object, and instructing, by the electronic device, based on the obtained interaction history, the AR device to display a piece of content selected from among a plurality of pieces of content on the object.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of a terminal device in a network environment, according to an embodiment of the disclosure;

FIG. 2 is a diagram illustrating a structure of a wearable augmented reality (AR) device according to an embodiment of the disclosure;

FIG. 3 is a diagram illustrating a camera and an eye tracking sensor of a wearable AR device, according to an embodiment of the disclosure;

FIG. 4 is a diagram illustrating an operation, performed by an electronic device, of determining a piece of content of an AR device, according to an embodiment of the disclosure;

FIG. 5 is a diagram illustrating a content selection operation of an electronic device, according to an embodiment of the disclosure;

FIG. 6 is a diagram illustrating an operation of selecting, based on an interaction history, a piece of content on an object, according to an embodiment of the disclosure;

FIG. 7 is a diagram illustrating a plurality of pieces of content mapped to a plurality of levels, according to an embodiment of the disclosure;

FIG. 8 is a diagram illustrating an operation of instructing an AR device to display pieces of content on a plurality of objects of an electronic device, according to an embodiment of the disclosure;

FIG. 9 is a diagram illustrating an operation of reselecting a piece of content on a detected object when an electronic device detects a new interaction, according to an embodiment of the disclosure; and

FIG. 10 is a diagram illustrating an operation of reselecting a piece of content on a detected object when an electronic device detects that the object is purchased, according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

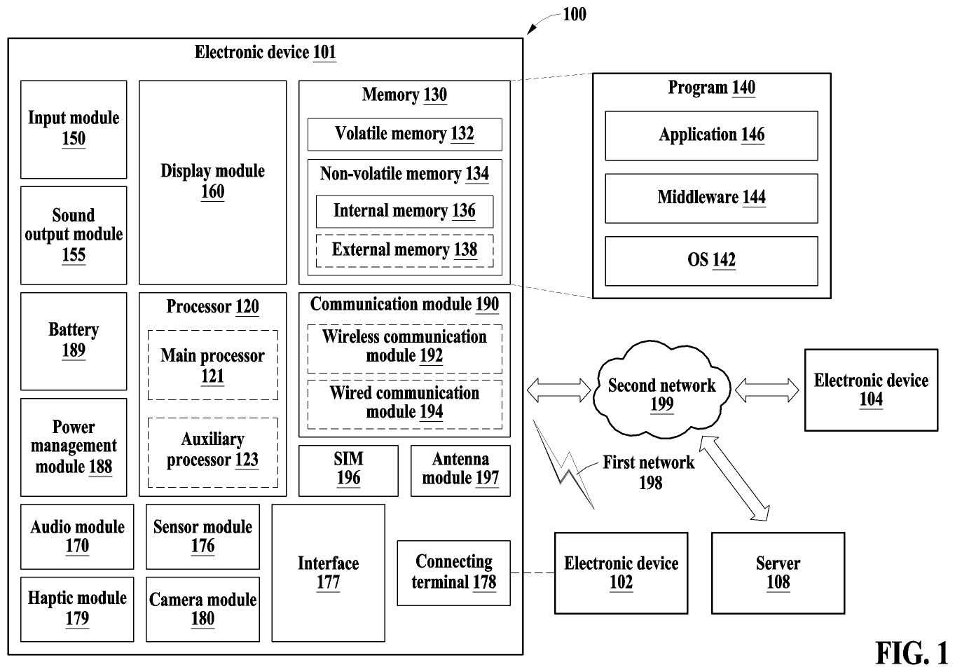

FIG. 1 is a block diagram illustrating a terminal device in a network environment, according to an embodiment of the disclosure.

Referring to FIG. 1, a terminal device 101 in a network environment 100 may communicate with an electronic device 102 via a first network 198 (e.g., a short-range wireless communication network) or communicate with at least one of an electronic device 104 or a server 108 via a second network 199 (e.g., a long-range wireless communication network). According to an embodiment, the terminal device 101 may communicate with the electronic device 104 via the server 108. According to an embodiment, the terminal device 101 may include a processor 120, memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the terminal device 101, or one or more other components may be added to the terminal device 101. In some embodiments, some (e.g., the sensor module 176, the camera module 180, or the antenna module 197) of the components may be integrated as a single component (e.g., the display module 160).

The processor 120 may execute, for example, software (e.g., the program 140) to control at least one other component (e.g., a hardware or software component) of the terminal device 101 connected to the processor 120 and performs various data processing or computation. According to an embodiment, as at least a part of data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently from, or in conjunction with the main processor 121. For example, when the terminal device 101 includes the main processor 121 and the auxiliary processor 123, the auxiliary processor 123 is adapted to consume less power than the main processor 121 or to be specific to a specified function. The auxiliary processor 123 may be implemented separately from the main processor 121 or as a portion of the main processor 121.

The auxiliary processor 123 may control at least some of functions or states related to at least one (e.g., the display module 160, the sensor module 176, or the communication module 190) of the components of the terminal device 101, instead of the main processor 121 while the main processor 121 is in an inactive (e.g., sleep) state or along with the main processor 121 while the main processor 121 is an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specified for artificial intelligence (AI) model processing. An AI model may be generated through machine learning. Such learning may be performed by, for example, the terminal device 101 in which AI is performed, or performed via a separate server (e.g., the server 108). A learning algorithm includes, but is not limited to, for example, supervised learning, unsupervised learning, semi-supervised learning, or reinforcement learning. The AI model may include a plurality of artificial neural network layers. An artificial neural network includes, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The AI model may additionally or alternatively include a software structure other than the hardware structure.

The memory 130 may store various pieces of data used by at least one component (e.g., the processor 120 or the sensor module 176) of the terminal device 101. The data includes, for example, software (e.g., the program 140) and input data or output data for a command related thereto. The memory 130 may include the volatile memory 132 or the non-volatile memory 134. The non-volatile memory may include internal memory 136 and external memory 138.

The program 140 may be stored as software in the memory 130 and includes, for example, an operating system (OS) 142, middleware 144, or an application 146.

The input module 150 may receive, from the outside (e.g., a user) of the terminal device 101, a command or data to be used by another component (e.g., the processor 120) of the terminal device 101. The input module 150 includes, for example, a microphone, a mouse, a keyboard, a key (e.g., a button), or a digital pen (e.g., a stylus pen).

The sound output module 155 may output a sound signal to the outside of the terminal device 101. The sound output module 155 includes, for example, a speaker or a receiver. The speaker may be used for general purposes, such as playing multimedia or playing a recording. The receiver may be used to receive an incoming call. According to an embodiment, the receiver may be implemented separately from the speaker or as a part of the speaker.

The display module 160 may visually provide information to the outside (e.g., a user) of the terminal device 101. The display module 160 includes, for example, a display, a hologram device, or a projector and a control circuit to control a corresponding one of the display, the hologram device, and the projector. According to an embodiment, the display module 160 may include a touch sensor adapted to sense a touch, or a pressure sensor adapted to measure the intensity of force incurred by the touch.

The audio module 170 may convert a sound into an electric signal or vice versa. According to an embodiment, the audio module 170 may obtain the sound via the input module 150 or output the sound via the sound output module 155 or an external electronic device (e.g., the electronic device 102 such as a speaker or headphones) directly or wirelessly connected to the terminal device 101.

The sensor module 176 may detect an operational state (e.g., power or temperature) of the terminal device 101 or an environmental state (e.g., a state of a user) external to the terminal device 101 and generate an electric signal or data value corresponding to the detected state. According to an embodiment, the sensor module 176 includes, for example, a gesture sensor, a gyro sensor, an atmospheric pressure sensor, a magnetic sensor, an acceleration sensor, a ultra-wide band (UWB) sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the terminal device 101 to be coupled with the external electronic device (e.g., the electronic device 102) directly (e.g., by wire) or wirelessly. According to an embodiment, the interface 177 includes, for example, a high-definition multimedia interface (HDMI), a universal serial bus (USB) interface, a secure digital (SD) card interface, or an audio interface.

The connecting terminal 178 may include a connector via which the terminal device 101 may be physically connected to an external electronic device (e.g., the electronic device 102). According to an embodiment, the connecting terminal 178 includes, for example, an HDMI connector, a USB connector, an SD card connector, or an audio connector (e.g., a headphone connector).

The haptic module 179 may convert an electrical signal into a mechanical stimulus (e.g., a vibration or a movement) or an electrical stimulus which may be recognized by a user via his or her tactile sensation or kinesthetic sensation. According to an embodiment, the haptic module 179 includes, for example, a motor, a piezoelectric element, or an electric stimulator.

The camera module 180 may capture a still image and moving images. According to an embodiment, the camera module 180 may include one or more lenses, image sensors, ISPs, or flashes.

The power management module 188 may manage power supplied to the terminal device 101. According to an embodiment, the power management module 188 is implemented as, for example, at least a part of a power management integrated circuit (PMIC).

The battery 189 may supply power to at least one component of the terminal device 101. According to an embodiment, the battery 189 includes, for example, a primary cell which is not rechargeable, a secondary cell which is rechargeable, or a fuel cell.

The communication module 190 may support establishing a direct (e.g., wired) communication channel or a wireless communication channel between the terminal device 101 and the external electronic device (e.g., the electronic device 102, the electronic device 104, or the server 108) and performing communication via the established communication channel. The communication module 190 may include one or more CPs that are operable independently from the processor 120 (e.g., an AP) and that support direct (e.g., wired) communication or wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., a LAN or a wide area network (WAN)). These various types of communication modules may be implemented as a single component (e.g., a single chip), or may be implemented as multiple components (e.g., multiple chips) separate from each other. The wireless communication module 192 may identify and authenticate the terminal device 101 in a communication network, such as the first network 198 or the second network 199, using subscriber information (e.g., international mobile subscriber identity (IMSI)) stored in the SIM 196.

The wireless communication module 192 may support a 5G network after a fourth generation (4G) network, and next-generation communication technology, for example, new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a millimeter wave (mmWave) band) to achieve, for example, a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 192 may support various requirements specified in the terminal device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the terminal device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or power may be transmitted or received between the communication module 190 and the external electronic device via the at least one selected antenna. According to an embodiment, another component (e.g., a radio frequency integrated circuit (RFIC)) other than the radiating element may be additionally formed as a part of the antenna module 197.

According to an embodiment, the antenna module 197 may form a mm Wave antenna module. According to an embodiment, the mm Wave antenna module may include a PCB, an RFIC disposed on a first surface (e.g., a bottom surface) of the PCB or adjacent to the first surface and capable of supporting a designated a high-frequency band (e.g., the mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and exchange signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the terminal device 101 and the external electronic device 104 via the server 108 coupled with the second network 199. Each of the external electronic devices 102 and 104 may be a device of the same type as or a different type from the terminal device 101. According to an embodiment, all or some of operations to be executed by the terminal device 101 may be executed at one or more of external electronic devices (e.g., the external devices 102 and 104, and the server 108). For example, if the terminal device 101 needs to perform a function or a service automatically, or in response to a request from a user or another device, the terminal device 101, instead of, or in addition to, executing the function or the service, may request one or more external electronic devices to perform at least part of the function or the service. The one or more external electronic devices receiving the request may perform the at least part of the function or the service requested, or an additional function or an additional service related to the request, and may transfer a result of the performance to the terminal device 101. The terminal device 101 may provide the result, with or without further processing the result, as at least part of a response to the request. To that end, cloud computing, distributed computing, mobile edge computing (MEC), or client-server computing technology may be used, for example. The terminal device 101 may provide ultra low-latency services using, e.g., distributed computing or MEC. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The terminal device 101 may be applied to intelligent services (e.g., a smart home, a smart city, a smart car, or healthcare) based on 5G communication technology or IoT-related technology.

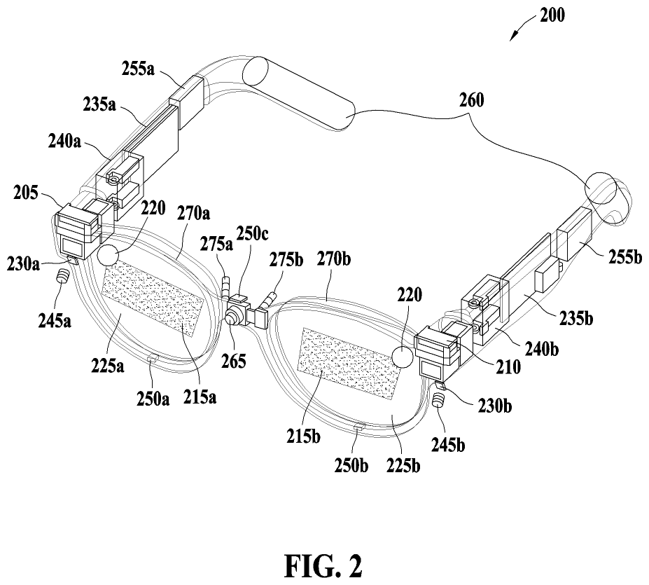

FIG. 2 is a diagram illustrating a structure of a wearable augmented reality (AR) device according to an embodiment of the disclosure.

Referring to FIG. 2, a wearable AR device 200 may be worn on a face of a user to provide an image associated with an AR service and/or a virtual reality service to the user.

In an embodiment, the wearable AR device 200 may include a first display 205, a second display 210, a screen display portion 215, an input optical member 220, a first transparent member 225a, a second transparent member 225b, lighting units 230a and 230b, a first PCB 235a, a second PCB 235b, a first hinge 240a, a second hinge 240b, first cameras 245a and 245b, a plurality of microphones (e.g., a first microphone 250a, a second microphone 250b, and a third microphone 250c), a plurality of speakers (e.g., a first speaker 255a and a second speaker 255b), a battery 260, second cameras 275a and 275b, a third camera 265, and visors 270a and 270b.

In an embodiment, a display (e.g., the first display 205 and the second display 210) includes, for example, a liquid crystal display (LCD), a digital mirror device (DMD), or a liquid crystal on silicon (LCoS), an organic light-emitting diode (OLED), a micro light-emitting diode (micro LED), or the like. Although not shown, when the display is one of an LCD, a DMD, and an LCOS, the wearable AR device 200 may include a light source configured to emit light to a screen output area of the display. In another embodiment, when the display is capable of generating light by itself, for example, when the display is either an OLED or a micro-LED, the wearable AR device 200 may provide a virtual image with a relatively high quality to the user even though a separate light source is not included. In an embodiment, when the display is implemented as an OLED or a micro LED, a light source may be unnecessary, and accordingly the wearable AR device 200 may be reduced in weight. Hereinafter, a display capable of generating light by itself may be referred to as a “self-luminous display”, and it can be assumed that relevant descriptions are referring to a self-luminous display.

A display (e.g., the first display 205 and the second display 210) according to an embodiment may include at least one micro-LED. For example, the micro-LED may express red (R), green (G), and blue (B) by emitting light by itself, and a single chip may implement a single pixel (e.g., one of R, G, and B pixels) because the micro-LED is relatively small in size (e.g., 100 micrometer (μm) or less). Accordingly, it may be possible to provide a high resolution without a backlight unit (BLU) when the display is implemented as a micro LED.

However, the embodiments are not limited thereto. A pixel may include R, G and B pixels, and a single chip may be implemented by a plurality of pixels including R, G, and B pixels.

In an embodiment, the display (e.g., the first display 205 and the second display 210) may be composed of a display area made up of pixels for displaying a virtual image, and light-receiving pixels (e.g., photo sensor pixels) that receive the light reflected from eyes disposed among pixels, convert the reflected light into electrical energy, and output light.

In an embodiment, the wearable AR device 200 may detect a gaze direction (e.g., a movement of a pupil) of the user through the light-receiving pixels. For example, the wearable AR device 200 detects and track a gaze direction of a right eye of the user and a gaze direction of a left eye of the user through one or more light-receiving pixels of the first display 205 and one or more light-receiving pixels of the second display 210. The wearable AR device 200 may determine a central position of a virtual image according to the gaze directions of the right eye and the left eye of the user (e.g., directions in which pupils of the right eye and the left eye of the user gaze) detected through the one or more light-receiving pixels.

In an embodiment, the light emitted from the display (e.g., the first display 205 and the second display 210) may reach the screen display portions 215a and 215b formed on the first transparent member 225a that faces the right eye of the user, and the screen display portions 215a and 215b formed on the second transparent member 225b that faces the left eye of the user, by passing through a lens (not shown) and a waveguide. For example, the light emitted from the display (e.g., the first display 205 and the second display 210) may be reflected from a grating area formed on the input optical member 220 and the screen display portions 215a and 215b to be delivered to the user's eyes, by passing through a waveguide. The first transparent member 225a and/or the second transparent member 225b may be formed as, for example, a glass plate, a plastic plate, or a polymer, and may be transparently or translucently formed.

In an embodiment, a lens (not shown) may be disposed on a front surface of the display (e.g., the first display 205 and the second display 210). The lens (not shown) may include a concave lens and/or a convex lens. For example, the lens (not shown) includes a projection lens or a collimation lens.

In an embodiment, the screen display portion 215 or the transparent member (e.g., the first transparent member 225a and the second transparent member 225b) may include a lens including a waveguide and a reflective lens.

In an embodiment, the waveguide may be formed of glass, plastic, or a polymer, and may have a nanopattern formed on one surface of the inside or outside, for example, a grating structure of a polygonal or curved shape. According to an embodiment, light incident to one end of the waveguide may be propagated inside the display waveguide through the nanopattern to be provided to a user. In an embodiment, a waveguide including a freeform prism may provide incident light to a user through a reflection mirror. The waveguide may include at least one of diffraction elements (e.g., a diffractive optical element (DOE) and a holographic optical element (HOE)) or at least one of reflective elements (e.g., a reflection mirror). In an embodiment, the waveguide may guide light emitted from the display 205, 210 to the eyes of the user, using the at least one diffractive element or the reflective element included in the waveguide.

According to an embodiment, the diffractive element may include the input optical member 220 and/or an output optical member (not shown). For example, the input optical member 220 refers to an input grating area, and the output optical member (not shown) refers to an output grating area. The input grating area may play a role as an input terminal which diffracts (or reflects) the light output from the display (e.g., the first display 205 and the second display 210) (e.g., a micro LED) to transmit the light to a transparent member (e.g., the first transparent member 225a and the second transparent member 225b) of the screen display portion 215. The output grating region may serve as an exit for diffracting (or reflecting), to the user's eyes, the light transmitted to the transparent members (e.g., the first transparent member 225a and the second transparent member 225b) of the waveguide.

According to an embodiment, reflective elements may include a total internal reflection optical element or a total internal reflection waveguide for total internal reflection (TIR). For example, TIR, which is one of schemes for inducing light, forms an angle of incidence such that light (e.g., a virtual image) entering through the input grating area is completely reflected from one surface (e.g., a specific surface) of the waveguide, to completely transmit the light to the output grating area.

In an embodiment, the light emitted from the first display 205 and the second display 210 may be guided by the waveguide through the input optical member 220. Light traveling in the waveguide may be guided toward the eyes of the user through the output optical member. The screen display portion 215 may be determined based on the light emitted toward the user's eyes.

In an embodiment, the first cameras 245a and 245b may include a camera used for 3 degrees of freedom (3DoF), head tracking of 6DoF, hand detection and tracking, gestures and/or space recognition. For example, the first cameras 245a and 245b includes a global shutter (GS) camera to detect a movement of a head or a hand and track the movement.

For example, a stereo camera is applied to the first cameras 245a and 245b for head tracking and space recognition, and a camera with the same standard and performance may be applied. A GS camera having excellent performance (e.g., image dragging) may be used for the first cameras 245a and 245b to detect a minute movement such as a quick movement of a hand or a finger and to track the movement.

According to various embodiments, a rolling shutter (RS) camera may be used for the first cameras 245a and 245b. The first cameras 245a and 245b may perform a simultaneous localization and mapping (SLAM) function through space recognition and depth capturing for 6Dof. The first cameras 245a and 245b may perform a user gesture recognition function.

In an embodiment, the second cameras 275a and 275b may be used for detecting and tracking the pupil. The second cameras 275a and 275b may be referred to as a camera for eye tracking (ET). The second camera 265a may track a gaze direction of the user. In consideration of the gaze direction of the user, the wearable AR device 200 may position a center of a virtual image projected on the screen display portion 215 according to the gaze direction of the user.

A GS camera may be used for the second cameras 275a and 275b to detect the pupil and track a quick pupil movement. The second camera 265a may be installed for a left eye or a right eye, and a camera having the same performance and standard may be used for the second camera 265a for the left eye and the right eye.

In an embodiment, the third camera 265 may be referred to as a “high resolution (HR)” or a “photo video (PV)”, and may include a high-resolution camera. The third camera 265 may include a color camera having functions for obtaining a high-quality image, such as an automatic focus (AF) and an optical image stabilizer (OIS). The embodiments are not limited thereto, and the third camera 265 may include a GS camera or a RS camera.

In an embodiment, at least one sensor (e.g., a gyro sensor, an acceleration sensor, a geomagnetic sensor, a UWB sensor, a touch sensor, an illuminance sensor and/or a gesture sensor) and the first cameras 245a and 245b may perform at least one of the functions among head tracking for 6DoF, pose estimation and prediction, gesture and/or space recognition, and a SLAM function through depth imaging.

In an embodiment, the first cameras 245a and 245b may be classified and used as a camera for head tracking or a camera for hand tracking.

In an embodiment, the lighting units 230a and 230b may be used differently according to positions at which the lighting units 230a and 230b are attached. For example, the lighting units 230a and 230b are attached together with the first cameras 245a and 245b mounted around a hinge (e.g., the first hinge 240a and the second hinge 240b) that connects a frame and a temple or around a bridge that connects frames. If capturing is performed using a GS camera, the lighting units 230a and 230b may be used to supplement a surrounding brightness. For example, the lighting units 230a and 230b are used in a dark environment or when it is not easy to detect a subject to be captured due to reflected light and mixing of various light sources.

In an embodiment, the lighting units 230a and 230b attached to the periphery of the frame of the wearable AR device 200 may be an auxiliary means for facilitating detection of an eye gaze direction when the second cameras 275a and 275b capture pupils. When the lighting units 230a and 230b are used as an auxiliary means for detecting the eye gaze direction, an IR LED of an IR wavelength may be included.

In an embodiment, a PCB (e.g., the first PCB 235a and the second PCB 235b) may include a processor (not shown), memory (not shown), and a communication module (not shown) that control components of the wearable AR device 200. The communication module may have the same configuration as the communication module 190 of FIG. 1, and the same description as the communication module 190 may be applicable to the communication module. For example, the communication module supports the establishment of a direct (or wired) communication channel or a wireless communication channel between the wearable AR device 200 and an external electronic device, and support the communication through the established communication channel. The PCB may transmit an electrical signal to the components constituting the wearable AR device 200.

The communication module (not shown) may include one or more CPs that are operable independently of the processor and that support a direct (e.g., wired) communication or a wireless communication. According to an embodiment, the communication module (not shown) may include a wireless communication module (e.g., a cellular communication module, a short-range wireless communication module, or a global navigation satellite system (GNSS) communication module) or a wired communication module (e.g., a LAN) communication module, or a PLC module). A corresponding one (not shown) of these communication modules may communicate with the external electronic device via a short-range communication network (e.g., Bluetooth™, Wi-Fi direct, or IrDA) or a long-range communication network (e.g., a legacy cellular network, a 5G network, a next-generation communication network, the Internet, or a computer network (e.g., a LAN or a WAN). These various types of communication modules may be implemented as a single component (e.g., a single chip), or may be implemented as multiple components (e.g., multiple chips) separate from each other.

The wireless communication module may support a 5G network after a 4G network, and next-generation communication technology, e.g., NR access technology. The NR access technology may support eMBB, mMTC, or URLLC. The wireless communication module may support a high-frequency band (e.g., a mm Wave band) to achieve, e.g., a high data transmission rate. The wireless communication module may support various technologies for securing performance on a high-frequency band, such as, e.g., beamforming, massive MIMO, FD-MIMO, an array antenna, analog beam-forming, or a large scale antenna.

The wearable AR device 200 may further include an antenna module (not shown). The antenna module may transmit or receive a signal or power to or from the outside (e.g., the external electronic device) of the wearable AR device 200. According to an embodiment, the antenna module may include an antenna including a radiating element including a conductive material or a conductive pattern formed in or on a substrate (e.g., the first PCB 235a and the second PCB 235b). According to an embodiment, the antenna module may include a plurality of antennas (e.g., array antennas).

In an embodiment, a plurality of microphones (e.g., the first microphone 250a, the second microphone 250b, and the third microphone 250c) may convert an external acoustic signal into electrical audio data. The processed audio data may be variously utilized according to a function (or an application being executed) being performed by the wearable AR device 200.

In an embodiment, the plurality of speakers (e.g., the first speaker 255a and the second speaker 255b) may output audio data received from the communication module or stored in the memory.

In an embodiment, one or more batteries 260 may be included, and may supply power to the components constituting the wearable AR device 200.

In one embodiment, the visors 270a and 270b may adjust a transmittance amount of external light incident on the user's eyes according to a transmittance. The visors 270a and 270b may be positioned in front or behind the screen display portion 215. A front side of the screen display portion 215 may mean a direction opposite to the user wearing the wearable AR device 200, and a rear side thereof may mean a direction of the user wearing the wearable AR device 200. The visors 270a and 270b may protect the screen display portion 215a and 215b and adjust a transmittance amount of external light.

For example, the visors 270a and 270b includes an electrochromic element that changes color according to applied power to adjust a transmittance. Electrochromism is a phenomenon in which an applied power triggers an oxidation-reduction reaction which causes a change in color. The visors 270a and 270b may adjust a transmittance of external light, using the color change of the electrochromic element.

For example, the visors 270a and 270b includes a control module and an electrochromic element. The control module may control the electrochromic element to adjust a transmittance of the electrochromic element.

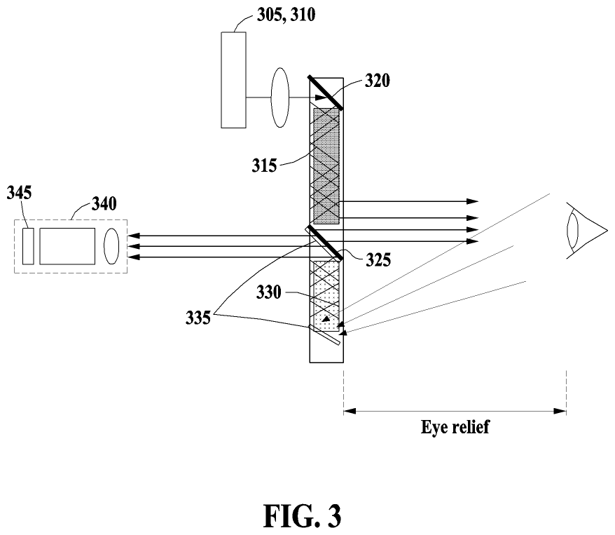

FIG. 3 is a diagram illustrating a camera and an eye tracking sensor of a wearable AR device according to one embodiment of the disclosure.

Referring to FIG. 3, an wearable AR device (e.g., the wearable AR device 200 of FIG. 2) may include displays 305 and 310 (e.g., the displays 205 and 210 of FIG. 2), an optical waveguide (or a waveguide) 315, an input optical member 320 (e.g., the input optical member 220 of FIG. 2), an output optical member 325, an eye tracking (ET) optical waveguide (or an ET waveguide) 330, an ET splitter 335, a camera 340 (e.g., the second cameras 275a and 275b), an ET sensor 345, and a lighting unit (e.g., the lighting units 230a and 230b of FIG. 2).

Referring to FIG. 3, light output from the displays 305 and 310 of the wearable AR device is incident to the input optical member 320 and transmitted to the user's eyes through the optical waveguide 315 and the output optical member 325.

Referring to FIG. 3, the camera 340 may obtain an image of the user's eye. For example, the image of the user's eye is input to the ET splitter 335 on the lower side and transmitted to the ET splitter 335 on the upper side through the ET optical waveguide 330. The camera 340 may obtain the image of the user's eye from the ET splitter 335 on the upper side.

The lighting unit according to one embodiment may output IR light to a user's pupil region. The IR light may be reflected from the user's pupil and transmitted to the ET splitter 335 together with the image of the user's eye. The image of the user's eye obtained by the camera 340 may include the reflected IR light. The ET sensor 345 may sense the IR light reflected from the user's pupil.

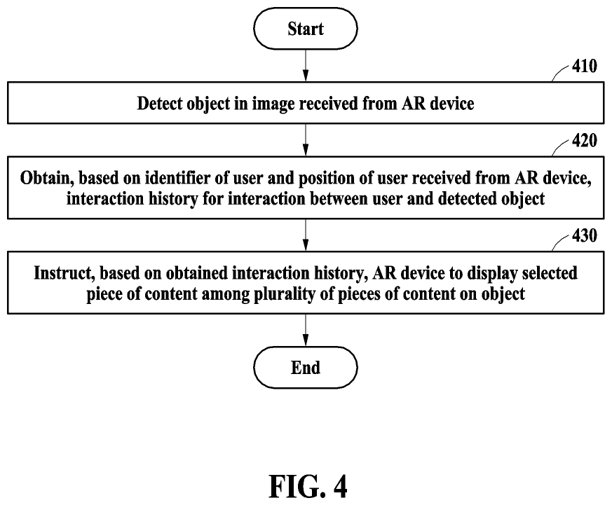

FIG. 4 is a diagram illustrating an operation, performed by an electronic device, of determining a piece of content of an AR device, according to an embodiment of the disclosure.

In operation 410, an electronic device (e.g., the terminal device 101 of FIG. 1 and the processor 120 of FIG. 1) may detect an object in an image received from an AR device (e.g., the electronic device 104 of FIG. 1 and the wearable AR device 200 of FIG. 2). For example, the AR device transmits an image obtained by capturing a region corresponding to a field of view of a user to the electronic device. The electronic device may receive, from the AR device, the image of the region corresponding to the field of view of the user. The electronic device may detect an object in the received image.

In operation 420, the electronic device may obtain an interaction history for an interaction between the user and the detected object. For example, the electronic device receives, from the AR device, an identifier of the user and the position of the user. The electronic device may obtain the interaction history, based on the received identifier and position of the user. The interaction history is a history of a previously detected interaction between the user and the object and may have a record of an interaction that may be used to select a piece of content to be displayed by the AR device.

The electronic device may detect the interaction between the user and the object. The electronic device may, in response to detecting an interaction, generate a record of the interaction. An interaction is an action performed by a user to obtain information about an object and may include an interaction between the user and the object to obtain information about the object.

For example, the interaction includes an action of the user gazing at the object or a predetermined portion of the object. The predetermined portion of the object may include a region having advanced information about the object. The advanced information about the object may include one or a combination of two or more of nutritional information, caffeine information, calorie information, expiration date information, intake method information, or storage method information. For example, the predetermined portion of the object includes a region corresponding to a label of the object. The label of the object may have information such as one or a combination of two or more of the trademark, product name, classification number, handling precautions, size, or price of the object.

For example, the interaction includes an action of the user touching the object with a portion (e.g., a hand) of the body of the user. For example, the interaction includes an action of the user generating an input for requesting additional information about the object. For example, the input for requesting additional information about the object includes an input for requesting additional information about the object based on a piece of content displayed by the AR device. For example, the interaction includes an action of the user generating an input for the piece of content to the AR device that displays the piece of content on the object. An input for a piece of content includes, for example, one or a combination of two or more of a request to terminate content, a request to move content, or a request to redisplay content of which display is terminated.

A record of an interaction may include information about the interaction. When the interaction between the user and the object is detected, the record of the interaction may be used as a means to record the interaction. For example, the record of the interaction includes one or a combination of two or more of the user of the interaction (or the identifier of the user), a space of the interaction, a duration of the interaction, a level of the interaction, an object of the interaction, or a type of object of the interaction.

The user of the interaction may be a user who obtains information about the object through the interaction. For example, information related to the identifier of the user may be included. The space of the interaction may be a space corresponding to the position of the user at a time point at which the electronic device detects the interaction. The duration of the interaction may be a time period during which the electronic device continuously detects the interaction, from the start time when the electronic device starts detecting the interaction to the end time when the electronic device stops detecting the interaction. The object of the interaction may be an object for information obtained by the user through the interaction. The type of the object of the interaction may be the type (e.g., snack, ramen, daily necessity, or fruit) of the object of the interaction classified according to a predetermined criterion.

The level of the interaction may be a value indicating the amount and/or depth of information about an object that may be obtained by the user through the interaction. For example, an interaction that allows the user to obtain the position and/or name of an object has interaction level 1. An interaction that allows the user to obtain information other than the information about the position and name of the object may have interaction level 2. An interaction that allows the user to obtain advanced information about the object may have interaction level 3. An interaction that allows the user to request additional information about the object may have interaction level 4.

For example, the action of the user gazing at, at least a portion of the object (e.g., a portion other than a predetermined portion of the object) is the interaction that allows the user to obtain the position and/or name of the object and has interaction level 1. The action of the user touching the object with a portion of the body of the user is the interaction that allows the user to obtain information other than the information about the position and name of the object and may have interaction level 2. The action of the user gazing at a predetermined portion of the object is the interaction that allows the user to obtain advanced information about the object and may have interaction level 3. The action of the user generating an input for requesting additional information about the object is the interaction that allows the user to request additional information about the object and may have interaction level 4. However, the examples of the interactions and the interaction levels described above are only examples for description, and embodiments are not limited thereto. For example, another action (e.g., an action other than the action of the user gazing at the object or a predetermined portion of the object, the action of the user touching the object with a portion of the body of the user, and the action of the user generating an input for requesting additional information about the object) may be detected as an interaction, and the detected other action may have an interaction level.

The electronic device may select at least one interaction record from among a plurality of interaction records, based on the identifier and/or position of the user, to obtain an interaction history including the selected interaction record. The electronic device may obtain the interaction history by selecting at least one of records of interactions between a plurality of users and objects detected in a plurality of spaces.

According to an embodiment, the electronic device may obtain an interaction history by selecting at least one of the records of the interactions between the plurality of users and the objects based on the identifier of the user received from the AR device. For example, the electronic device selects a record of an interaction between a target user and an object, based on the identifier of the user received from the AR device. The target user may be a user corresponding to the identifier of the user received from the AR device among a plurality of users.

According to an embodiment, the electronic device may obtain, based on the position of the user received from the AR device, an interaction history by selecting at least some of the records of the interactions in the plurality of spaces. The electronic device may determine a target space corresponding to the position of the user received from the AR device. The position of the user includes, for example, position information of the user measured by a global positioning system (GPS). The target space is a space corresponding to the position of the user and may include a space that includes the position of the user. For example, the target space includes a store (e.g., convenience store A, mart B, or clothing store C) that the user enters.

For example, the electronic device obtains an interaction history for an interaction in the target space. The electronic device may select a record of the interaction in the target space from among records of interactions in the plurality of spaces.

For example, the electronic device obtains an interaction history for an interaction in another space related to the target space together with the interaction in the target space. The electronic device may obtain an interaction history that further includes a record of an interaction in another space related to the target space together with the record of the interaction in the target space. The electronic device may select, from among records of interactions in the plurality of spaces, the record of the interaction in the target space and the record of the interaction in another space related to the target space. Another space related to the target space may include another space of the same type (e.g., supermarket, convenience store, or clothing store).

According to an embodiment, the electronic device may obtain, based on the identifier and the position of the user received from the AR device, the interaction history by selecting at least some of the records of the plurality of interactions between the plurality of objects and the plurality of users.

For example, the electronic device obtains an interaction history having a record of the interaction between the target user and the object in the target space. The electronic device may select, from among records of the plurality of interactions, the record of the interaction between the user and the object in the target space.

For example, the electronic device obtains an interaction history having the record of the interaction in the target space and the record of the interaction between the target user and the object in another space related to the target space. The electronic device may select, from among the records of the plurality of the interactions, the record of the interaction between the target user and the object in the target space together with the record of the interaction between the target user and the object in another space related to the target space.

In operation 430, the electronic device may instruct the AR device to display a piece of content selected based on the interaction history from among a plurality of pieces of content on an object detected in the image. A piece of content may have information about an object corresponding to the piece of content. For example, a piece of content that the electronic device instructs the AR device to display may have information about the object.

According to an embodiment, the electronic device may instruct the AR device to display a piece of content by transmitting a selected piece of content on a detected object to the AR device. For example, the electronic device selects, based on the interaction history, at least one piece of content from among a plurality of pieces of content on the detected object. The electronic device may transmit the at least one selected piece of content to the AR device. The AR device may receive at least one selected piece of content from the electronic device. The AR device may provide a piece of customized content to the user by displaying at least one piece of received content.

According to an embodiment, the electronic device may instruct the AR device to display the piece of content by transmitting, to the AR device, information about the selected piece of content on the detected object. For example, the electronic device selects, from among a plurality of pieces of content on the object detected based on the interaction history, at least one piece of content. The electronic device may transmit, to the AR device, information indicating at least one piece of content selected from among the plurality of pieces of content on the detected object. The AR device may receive information indicating at least one piece of content from the electronic device. The AR device may provide, based on the received information, a piece of content customized to the user by displaying at least one piece of content selected from among the plurality of pieces of content on the detected object.

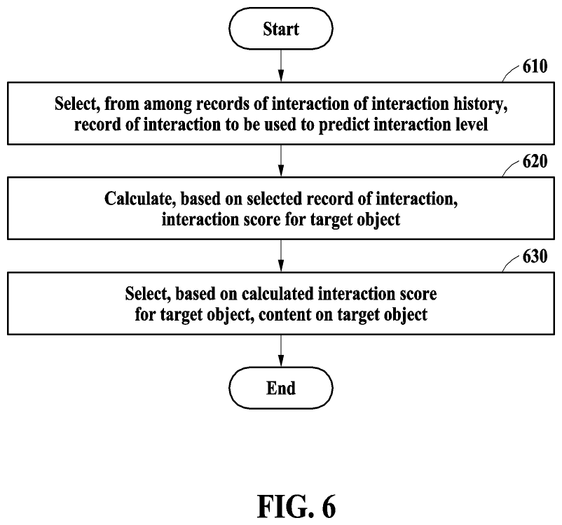

An embodiment of selecting a piece of content on a detected object of the electronic device and an embodiment of instructing an AR device to display the selected piece of content are described below with reference to FIG. 6.

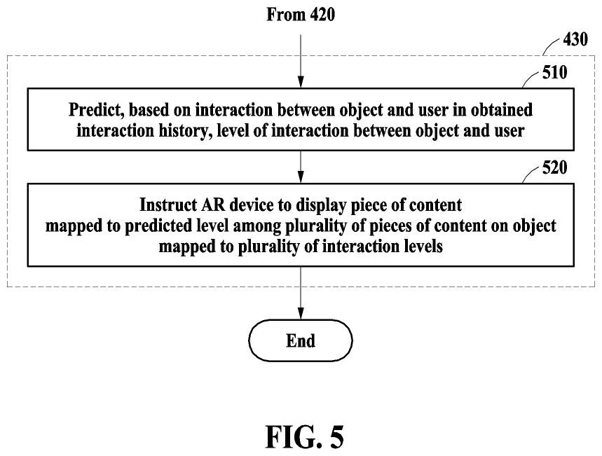

FIG. 5 is a diagram illustrating a content selection operation of the electronic device, according to an embodiment of the disclosure.

The electronic device according to an embodiment may select, based on an interaction history, at least one piece of content on an object from among a plurality of pieces of contents.

In operation 510, the electronic device may predict, based on the obtained interaction history, the level of the interaction between the detected object and a user. For example, the electronic device predicts, based on the interaction between the detected object and the user in the interaction history, the level of the interaction between the detected object and the user. For example, the electronic device predicts the level of the interaction between the detected object and the user, based on the interaction between the user and another object related to the detected object together with the interaction between the detected object and the user in the interaction history.

According to an embodiment, the electronic device may select, from among records of interactions included in the interaction history, a record of an interaction to be used to predict the level of the interaction between the user and the detected object. For example, the electronic device selects, from among the records of the interactions between the user and the plurality of objects, the record of the interaction between the user and the detected object. For example, the electronic device selects, from among records of interactions between the user and the plurality of objects, the record of the interaction between the user and the detected object and the record of the interaction between the user and another object related to the detected object. The electronic device may predict the level of an interaction for the detected object, based on a score calculated based on a record of a selected interaction.

In operation 520, the electronic device may instruct the AR device to display a piece of content mapped to the predicted level. The electronic device may instruct the AR device to display the piece of content mapped to the predicted level among the plurality of pieces of content on the detected object. According to an embodiment, the plurality of pieces of content on the detected object may be mapped to interaction levels. For example, a piece of content with more information about an object is mapped to a higher interaction level. When a first piece of content on the detected object has more information than a second piece of content on the detected object, the first piece of content may be mapped to a higher interaction level than the second piece of content.

According to an embodiment, the electronic device may instruct the AR device to display a piece of content on the detected object in a region determined based on display information. The display information may include displayed positions of objects displayed in a space (e.g., a target space) corresponding to the position of the user. For example, the display information includes three-dimensional (3D) reconstruction data.

The electronic device may determine, based on the display information about the positions where an object is detected in the target space, a region to display a piece of content on the detected object. The electronic device may determine a region to display a piece of content, based on a region corresponding to the object detected by the AR device. The region (e.g., an object region) corresponding to the detected object may be a partial region in which light reflected from the detected object and directed to an eye of the user passes through a transparent display of the AR device and/or a partial region in which the detected object is displayed on the display of the AR device.

For example, the electronic device instructs the AR device to overlay a piece of content on at least a portion of the object region. The electronic device may instruct the AR device to display the center of the object region of the detected object and the center of a piece of content on the same position.

For example, the electronic device instructs the AR device to display a piece of content in a region spaced apart from the object region of the detected object. A region in which the AR device displays a piece of content may be determined as a region that is separated from the object region by a distance greater than or equal to a first threshold distance and within a threshold distance from the object region. For example, the minimum distance between a first point of the object region and a second point of the separated region has to be greater than or equal to the first threshold distance and less than or equal to a second threshold distance.

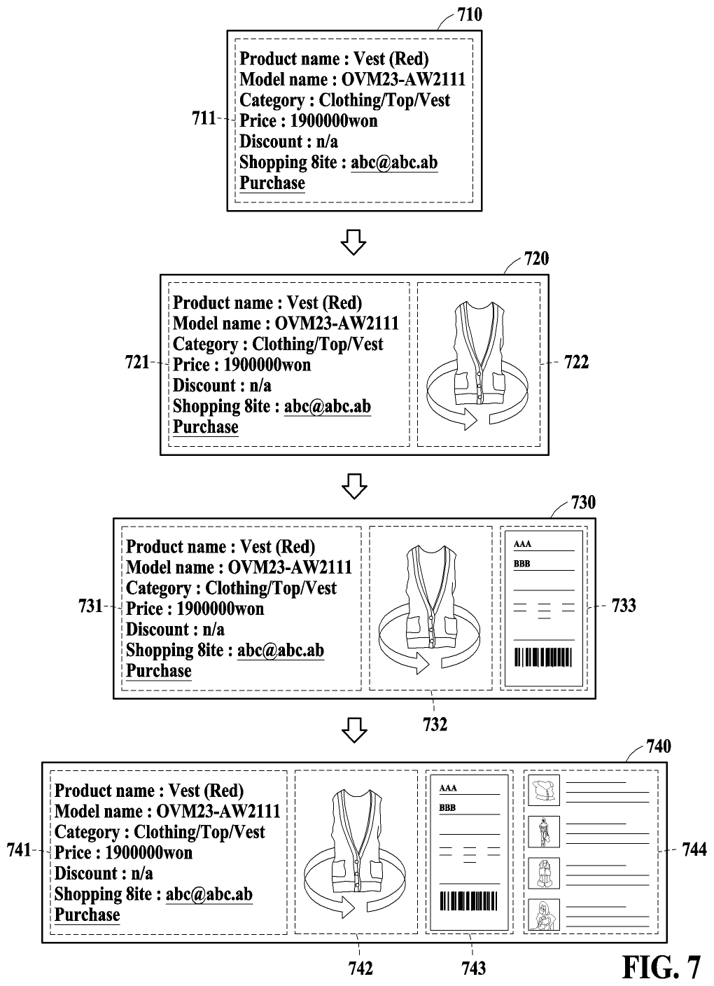

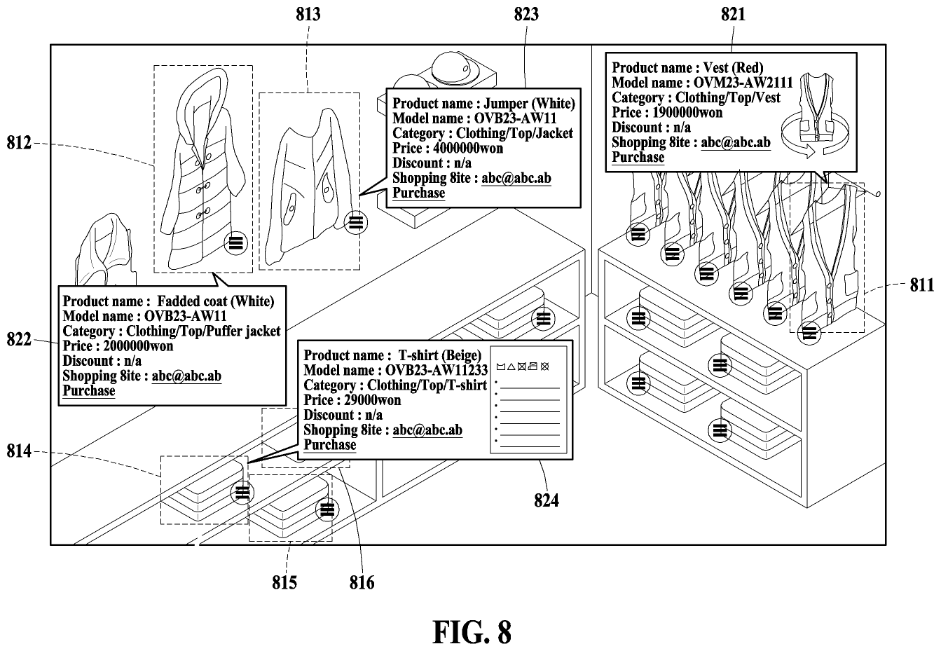

An operation of instructing the AR device to display a piece of content of the electronic device is described below with reference to FIGS. 7 and 8.

Herein, an interaction is mainly described as an action to obtain information about an object, which is a product, but is not limited thereto. Information about an object obtainable through an interaction may include information about a service related to the object. For example, an interaction includes an action to obtain information about a service related to an object.

For example, a service related to an object includes one or a combination of two or more of a service for providing the object to the user or an after service for maintenance of the object.

For example, a service related to a water purifier includes a water purifier rental service that provides a user with a water purifier on a rental basis for a predetermined period of time. In the case of the water purifier rental service, a piece of content on the water purifier to be displayed by the AR device may include one or a combination of two or more of price information of the service of renting the water purifier, information about the water purifier provided through the service, or discount information of the service.

For example, a service related to a mobile phone includes a mobile phone after service for repairing a mobile phone. In the case of the mobile phone after service, a piece of content on the mobile phone to be displayed by the AR device may include one or a combination of two or more of price information required for repair of the mobile phone, expected waiting time required for repair of the mobile phone, or whether the mobile phone may be repaired.

FIG. 6 is a diagram illustrating an operation of selecting, based on an interaction history, a piece of content on an object, according to an embodiment of the disclosure.

Referring to FIG. 6, an electronic device (e.g., the terminal device 101 of FIG. 1) may select a piece of content from among a plurality of pieces of content on an object detected based on at least a portion of an obtained interaction history. For example, the electronic device predicts the level of the interaction between the detected object and a user. The electronic device may select a piece of content mapped to the predicted level of the interaction from among a plurality of pieces of content on the The electronic device may obtain an interaction history based on the position of the user and the identifier of the user. For example, the interaction history has records of a plurality of interactions between a target user and an object. The interaction history may have a record of a first interaction, a record of a second interaction, a record of a third interaction, a record of a fourth interaction, a record of a fifth interaction, and a record of a sixth interaction. The record of each interaction is information about the interaction and may include the duration of the interaction, the level of the interaction, the object of the interaction, and the type of the object of the interaction.

Table 1 is an example of an interaction history for the interaction between the user and the object, according to an embodiment.

TABLE 1

| | Duration | Level | Object | Object Type |
|---|---|---|---|---|
| Record of the first | 2022 Feb. 22 | 2 | A ramen | Ramen |
| interaction | 14:00-14:01 | | | |
| Record of the second | 2022 Feb. 22 | 1 | B ramen | Ramen |
| interaction | 14:01-14:06 | | | |
| Record of the third | 2022 Feb. 22 | 3 | C toothpaste | Necessity |
| interaction | 14:06-14:07 | | | |
| Record of the fourth | 2022 Feb. 22 | 4 | D snack | Snack |
| interaction | 15:10-15:11 | | | |
| Record of the fifth | 2022 Feb. 22 | 2 | E fruit | Fruit |
| interaction | 16:10-16:11 | | | |
| Record of the sixth | 2022 Feb. 22 | 1 | A ramen | Ramen |
| interaction | 16:15-16:17 | | | |

In operation 610, the electronic device may select a record of an interaction to be used for selecting a piece of content from among records of a plurality of interactions of the interaction history. According to an embodiment, the electronic device may select, based on the interaction between the user and an object detected in the interaction history, a piece of content on the detected object. For example, the electronic device predicts the level of the interaction between the detected object and the user using a record of the interaction between the use and the detected object in the interaction history. The electronic device may select a record of the interaction between the detected object and the user from among records of a plurality of interactions of the interaction history. For example, the detected object is A ramen. The electronic device may select, from among the records of the plurality of interactions of the interaction history, the record of the first interaction and the record of the sixth interaction.

According to an embodiment, the electronic device may select a piece of content on the detected object, based on the interaction between the user and another object related to the detected object in the interaction history. For example, the interaction between the detected object and the user is predicted by using a record of the interaction between the user and another object related to the detected object in the interaction history. The electronic device may select, from among the records of the plurality of interactions in the interaction history, the record of the interaction between the user and another object related to the detected object. Another object related to the detected object may include, for example, an object having the same type of object as the detected object. For example, the detected object is A ramen. Another object related to the detected object may be B ramen. The electronic device may select the record of the second interaction from among the records of the plurality of interactions in the interaction history.

According to an embodiment, the electronic device may select a piece of content on the detected object, based on the interaction between the user and another object related to the detected object, together with the interaction between the user and the detected object in the interaction history. For example, the electronic device predicts the level of the interaction between the detected object and the user by using both a record of the interaction between the user and the detected object and a record of the interaction between the user and another object related to the detected object. The electronic device may select, from among the records of the plurality of interactions in the interaction history, the record of the interaction between the user and another object related to the detected object. For example, the detected object is B ramen. Another object related to the detected object may be A ramen. The electronic device may select, from among records of the plurality of interactions in the interaction history, the record of the first interaction, the record of the second interaction, and the record of the sixth interaction.

In operation 620, the electronic device may calculate an interaction score for the detected object, based on the record of the selected interaction. The interaction score for the detected object may be a value representing the possibility that the user performs an action (e.g., an interaction) to obtain information about the detected object and/or the amount (or depth) of information about the detected object that the user is expected to attempt to obtain.

The electronic device may predict, based on an interaction history having a record of a past interaction between the target user and the detected object (or another object related to the detected object), whether the interaction between the target user and the detected object is to be detected and/or the level of interaction between the detected object and the target user to be detected afterwards.

According to an embodiment, the electronic device may calculate an interaction score for the detected object using a weight assigned to an interaction level. A plurality of weights may correspond to a plurality of interaction levels. For example, a first weight (e.g., 1) is assigned to interaction level 1. A second weight (e.g., 10) may be assigned to interaction level 2. A third weight (e.g., 100) may be assigned to interaction level 3. A fourth weight (e.g., 1,000) may be assigned to interaction level 4.

According to an embodiment, the electronic device may calculate an interaction score for the detected object using a weight assigned to the level of the interaction between the user and the detected object, with respect to the interaction between the user and the detected object in the interaction history. As described above, the electronic device may select, from the interaction history, a record of an interaction to be used to predict an interaction level. For example, the electronic device calculates an interaction score for the selected record of the interaction by multiplying a weight assigned to an interaction level by the time length of the duration of an interaction. For example, the electronic device selects records of the plurality of interactions from the interaction history. For each of the selected records of the interactions, the electronic device may calculate a partial score for a corresponding record of an interaction by multiplying a weight assigned to the interaction level of the corresponding record of the interaction by the time length of the duration of the interaction of the corresponding record of the interaction. The electronic device may calculate an interaction score for the detected object by summing the partial scores for the selected plurality of records of the interactions. The time length of the duration, for example, has a unit of minutes but is not limited thereto and may be changed to hours, seconds, and the like depending on the design.

In Table 1, for example, the detected object is A ramen. The electronic device may select, from among the records of the plurality of interactions in the interaction history, the record of the first interaction and the record of the sixth interaction as the records of the interactions between the detected object and the user. For the record of the first interaction, the electronic device may calculate a partial score (e.g., 10) for the record of the first interaction by multiplying a weight (e.g., 10) assigned to interaction level 2 by the time length (e.g., 1) of the duration of the interaction. For the record of the sixth interaction, the electronic device may calculate a partial score (e.g., 2) for the record of the sixth interaction by multiplying a weight (e.g., 1) assigned to interaction level 1 by the time length (e.g., 2) of the duration of the interaction. The electronic device may calculate an interaction score (e.g., 12) for the detected object (e.g., A ramen) by summing the partial score (e.g., 10) for the record of the first interaction and the partial score (e.g., 2) for the record of the sixth interaction.

According to an embodiment, the electronic device may calculate an interaction score for the detected object using a weight less than a weight assigned to the level of the interaction between the user and another object with respect to the interaction between the user and another object related to the detected object in the interaction history. For example, instead of the weight assigned to the level of the interaction between another object and the user, the electronic device is a weight assigned to a level, which is one level lower than the level of the interaction between the user and another object. As described above, the electronic device may select the record of the interaction between the user and another object related to the detected object in the interaction history. When the object of an interaction is an object other than the detected object, the electronic device may calculate an interaction score and/or a partial score using a weight less than a weight assigned to the level of the interaction. For example, with respect to the record of the interaction between the user and another object related to the detected object, the electronic device calculates an interaction score and/or a partial score by multiplying the weight less than the weight assigned to the level of the interaction by the time length of the duration of the interaction.

In Table 1, for example, the detected object is F ramen. The electronic device may select, from among the records of the plurality of interactions in the interaction history, the record of the first interaction, the record of the second interaction, and the record of the sixth interaction as the records of the interactions between the user and another object related to the detected object. With respect to the record of the first interaction, the electronic device may calculate a partial score (e.g., 1) for the record of the first interaction by multiplying a weight (e.g., 1) less than the weight (e.g., 10) assigned to interaction level 2 by the time length (e.g., 1) of the duration of the interaction. With respect to the record of the second interaction, the electronic device may calculate a partial score (e.g., 0) for the record of the second interaction by multiplying a weight (e.g., 0) less than the weight (e.g., 1) assigned to interaction level 1 by the time length (e.g., 5) of the duration of the interaction. With respect to the record of the sixth interaction, the electronic device may calculate a partial score (e.g., 0) for the record of the sixth interaction by multiplying a weight (e.g., 0) less than the weight (e.g., 1) assigned to interaction level 1 by the time length (e.g., 2) of the duration of the interaction. The electronic device may calculate an interaction score (e.g., 1) for the detected object (e.g., F ramen) by summing the partial score (e.g., 1) for the record of the first interaction, the partial score (e.g., 0) for the record of the second interaction, and the partial score (e.g., 0) for the record of the sixth interaction.

According to an embodiment, the electronic device may calculate the interaction score for the detected object using a weight less than the weight assigned to the interaction between the user and another object related to the detected object, together with the weight assigned to the level of the interaction between the user and the detected object. As described above, the electronic device may select, from the interaction history, the record of the interaction between the user and another object related to the detected object, together with the record of the interaction between the user and the detected object. For example, with respect to the record of the interaction between the user and the detected object, the electronic device calculates the partial score for the record of the interaction using the weight assigned to the level of the interaction. With respect to the record of the interaction between the user and another object related to the detected object, the electronic device may calculate the partial score for the record of the interaction using a weight less than the weight assigned to the level of the interaction.

In Table 1, for example, the detected object is B ramen. The electronic device may select, from among the plurality of records of the interactions of the interaction history, the record of the second interaction as the record of the interaction between the user and the detected object and the record of the first interaction and the record of the sixth interaction as records of the interaction between the user and another object related to the detected object. With respect to the record of the first interaction for the interaction between the user and another object, the electronic device may calculate the partial score (e.g., 1) for the record of the first interaction by multiplying a weight (e.g., 1) less than the weight (e.g., 10) assigned to interaction level 2 by the time length (e.g., 1) of the duration of the interaction. With respect to the record of the second interaction for the interaction between the user and the detected object, the electronic device may calculate the partial score (e.g., 5) for the record of the second interaction by multiplying the weight (e.g., 1) assigned to interaction level 1 by the time length (e.g., 5) of the duration of the interaction. With respect to the record of the sixth interaction for the interaction between the user and another object, the electronic device may calculate the partial score (e.g., 0) for the record of the sixth interaction by multiplying a weight (e.g., 0) less than the weight (e.g., 1) assigned to interaction level 1 by the time length (e.g., 2) of the duration of the interaction. The electronic device may calculate an interaction score (e.g., 6) for the detected object (e.g., F ramen) by summing the partial score (e.g., 1) for the record of the first interaction, the partial score (e.g., 5) for the record of the second interaction, and the partial score (e.g., 0) for the record of the sixth interaction.

In operation 620, the electronic device may select a piece of content on the detected object, based on the calculated interaction score for the detected object.

According to an embodiment, the electronic device may predict an interaction level corresponding to a score range including the calculated interaction score as the interaction level for the detected object. The electronic device may select, from among a plurality of pieces of content on the detected object, a piece of content mapped to the level of the interaction predicted for the detected object.

For example, a plurality of interaction levels corresponds to a plurality of score ranges. Each of the plurality of interaction levels may correspond to a single score range. For example, interaction level 1 corresponds to a first score range from 10 to less than 100. Interaction level 2 may correspond to a second score range from 100 to less than 1,000. Interaction level 3 may correspond to a third score range from 1,000 to less than 10,000. Interaction level 4 may correspond to a third score range from 10,000 to less than 100,000. The electronic device may calculate the interaction score for the detected object to be 200. The electronic device may predict the level of the interaction of the detected object as interaction level 2 corresponding to the second score range including the interaction score for the detected object.

According to an embodiment, when a score range including the calculated interaction score exists, the electronic device may predict an interaction level corresponding to the score range as the interaction level for the detected object. When the score range including the calculated interaction score does not exist, the electronic device may predict an interaction level by comparing the interaction score with a threshold score.

For example, the plurality of interaction levels corresponds to at least one of the plurality of score ranges and/or the threshold score. For example, interaction level 0 corresponds to a first threshold score of 10. Interaction level 1 may correspond to the first score range from 10 to less than 100. Interaction level 2 may correspond to the second score range from 100 to less than 1,000. Interaction level 3 may correspond to the third score range from 1,000 to less than 10,000. Interaction level 4 may correspond to a second threshold score of 10,000. For reference, interaction level 0 may indicate that the interaction between the user and the detected object is not to be detected. For example, the electronic device calculates the interaction score to be 5. The electronic device may determine that the score range including the interaction score does not exist. The electronic device may predict, based on the interaction score being less than the first threshold score, interaction level 0 as the interaction level for the detected object. For example, the electronic device calculates the interaction score to be 200. The electronic device may predict the interaction level of the detected object as interaction level 2 corresponding to the second score range including the interaction score. For example, the electronic device calculates the interaction score to be 150,000. The electronic device may determine that the score range including the interaction score does not exist. The electronic device may predict, based on the interaction score being greater than or equal to the second threshold score, interaction level 4 as the interaction level for the detected object.

FIG. 7 is a diagram illustrating a plurality of pieces of content mapped to a plurality of levels, according to an embodiment of the disclosure.

As described above, an electronic device may instruct an AR device to display a piece of content selected from among a plurality of pieces of content 710, 720, 730, and 740 for a detected object. The plurality of pieces of content 710, 720, 730, and 740 for the detected object may be mapped to a plurality of interaction levels.

According to an embodiment, a piece of content among the plurality of pieces of content 710, 720, 730, and 740 for the detected object may include information independent of the other pieces of content. Although not explicitly shown in FIG. 7, a piece of content corresponding to interaction level 1 may include trademark information for the detected object. A piece of content corresponding to interaction level 2 may include nutritional information for the detected object.

According to an embodiment, a piece of content among the plurality of pieces of content 710, 720, 730, and 740 for the detected object may include information included in the other pieces of content. For example, among the plurality of pieces of content 710, 720, 730, and 740 for the detected object, a piece of content mapped to a first interaction level further includes additional information to the information included in a piece of content mapped to a second interaction level lower than the first interaction level.

Referring to FIG. 7, each of a plurality of pieces of sub-content on the detected object may correspond to an interaction level. A piece of content mapped to an interaction level may include one or a combination of two or more of the plurality of pieces of sub-content determined based on a corresponding interaction level. For example, a first piece of sub-content 711, 721, 731, 741 includes information such as one or a combination of two or more of the product name, model name, category, price, discount, or sales website of the detected object. For example, a second piece of sub-content 722, 732, 742 includes an image of the detected object. The AR device that displays the image of the detected object may display an image selected according to an input of a user from among images of the detected object obtained by capturing the detected object in a plurality of directions. The AR device may change the displayed image by replacing the image captured in a first direction with an image captured in a second direction. For example, a third piece of sub-content 733, 743 includes information (e.g., the advanced information described above with reference to FIG. 4) included in the label of the detected object. For example, a fourth piece of sub-content 744 includes price comparison information for the detected object.

A piece of content mapped to an interaction level may include a piece of sub-content corresponding to an interaction level less than or equal to the interaction level to which the piece of content is mapped. The first piece of sub-content 711, 721, 731, 741, the second piece of sub-content 722, 732, 742, the third piece of sub-content 733, 743, and the fourth piece of sub-content 744 may respectively correspond to interaction level 1, interaction level 2, interaction level 3, and interaction level 4. The piece of content 710 mapped to interaction level 1 may include the first piece of sub-content 711. The piece of content 720 mapped to interaction level 2 may include the first piece of sub-content 721 and the second piece of sub-content 722. The piece of content 730 mapped to interaction level 3 may include the first piece of sub-content 731, the second piece of sub-content 732, and the third piece of sub-content 733. The piece of content 740 mapped to interaction level 4 may include the first piece of sub-content 741, the second piece of sub-content 742, the third piece of sub-content 743, and the fourth piece of sub-content 744.

FIG. 8 is a diagram illustrating an operation of instructing an AR device to display pieces of content on a plurality of objects of an electronic device, according to an embodiment of the disclosure.

According to an embodiment, the electronic device may detect a plurality of objects in an image received from the AR device. For example, the electronic device detects the plurality of objects included in an image for a region corresponding to a field of view of a user. Referring to FIG. 8, the electronic device may detect a first object 811, a second object 812, a third object 813, a fourth object 814, a fifth object 815, and a sixth object 816.

The electronic device may select a piece of content on each of the plurality of objects, in response to detecting the plurality of objects in the image. For example, the electronic device predicts an interaction level for each of the plurality of objects, in response to detecting the plurality of objects. Referring to FIG. 8, the electronic device may predict, based on an interaction history, the interaction level for the first object 811 as interaction level 3. The electronic device may predict the interaction level for the second object 812 as interaction level 1. The electronic device may predict the interaction level for the third object 813 as interaction level 1. The electronic device may predict the interaction level for the fourth object 814 as interaction level 2. The electronic device may predict the interaction level for the fifth object 815 as interaction level 0. The electronic device may predict the interaction level for the sixth object 816 as interaction level 0.

With respect to each of the plurality of detected objects, the electronic device may instruct the AR device to display a selected piece of content on a corresponding object. For example, the electronic device instructs the AR device to display a piece of content mapped to an interaction level predicted for a corresponding object. When no piece of content mapped to the interaction level predicted for the corresponding object exists, the electronic device may instruct the AR device to skip displaying a piece of content on the corresponding object. For example, there is no piece of content mapped to interaction level 0. When the interaction level predicted for the corresponding object is interaction level 0, the electronic device may instruct the AR device to skip displaying a piece of content on the corresponding object.

Referring to FIG. 8, the electronic device may instruct the AR device to display a piece of content 821 mapped to interaction level 3 predicted for the first object 811. The electronic device may instruct the AR device to display a piece of content 822 mapped to interaction level 1 predicted for the second object 812. The electronic device may instruct the AR device to display a piece of content 823 mapped to interaction level 1 predicted for the third object 813. The electronic device may instruct the AR device to display a piece of content 824 mapped to interaction level 2 predicted for the fourth object 814. The electronic device may instruct, based on the absence of a piece of content mapped to interaction level 0 predicted for the fifth object 815, the AR device to skip displaying a piece of content on the fifth object 815. The electronic device may instruct, based on the absence of a piece of content mapped to interaction level 0 predicted for the sixth object 816, the AR device to skip displaying a piece of content on the sixth object 816.

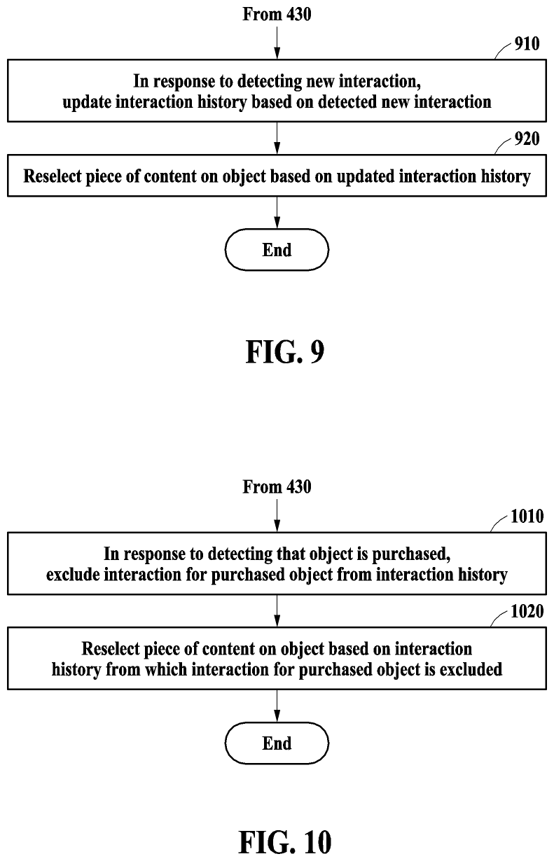

FIG. 9 is a diagram illustrating an operation of reselecting a piece of content on a detected object when an electronic device detects a new interaction, according to an embodiment of the disclosure.

Referring to FIG. 9, in operation 910, an electronic device (e.g., the terminal device 101 of FIG. 1) may detect a new interaction between a user and an object in a space corresponding to the position of the user. The electronic device may, in response to detecting the new interaction, update an interaction history based on the new interaction. For example, the electronic device, in response to detecting the new interaction, generates a record of the new interaction. The electronic device may update the interaction history by adding the record of the new interaction to the interaction history.

The electronic device may use not only a past interaction detected when the user visited a target space in the past but also a current interaction detected after the user enters the target space to select a piece of content by updating the interaction history based on the newly detected interaction.

In operation 920, the electronic device may reselect a piece of content on the detected object, based on the updated interaction history.

According to an embodiment, the electronic device may select the piece of content on the detected object, based on the interaction between the detected object and the user. For example, when detecting the new interaction between the detected object and the user, the electronic device predicts the interaction level for the detected object again based on the new interaction. When detecting a new interaction between another object and the user, the electronic device may skip reselecting a piece of content on the detected object. Alternatively, when detecting the new interaction between another object and the user, the electronic device may select the same piece of content, even when the electronic device reselects the piece of content on the detected object, based on the new interaction.

According to an embodiment, the electronic device may reselect the piece of content on the detected object, based on the interaction between the user and another object related to the detected object together with the interaction between the user and the detected object. For example, when detecting the new interaction between the detected object and the user, the electronic device predicts the interaction level for the detected object again, based on the new interaction. When detecting the new interaction between the user and another object related to the detected object, the electronic device may reselect the piece of content on the detected object, based on the new interaction. When detecting the new interaction between the user and an object unrelated to the detected object, the electronic device may skip reselecting the piece of content on the detected object. Alternatively, when detecting the new interaction between the user and the object unrelated to the detected object, the electronic device may select the same piece of content, even when the electronic device reselects the piece of content on the detected object further, based on the new interaction. The object unrelated to the detected object may be, for example, an object not related to the detected object, wherein the object is different from the detected object and another object related to the Although not explicitly shown in FIG. 9, the electronic device may instruct the AR device to display the reselected piece of content.

FIG. 10 is a diagram illustrating an operation of reselecting a piece of content on a detected object when an electronic device detects that the object is purchased, according to an embodiment of the disclosure.

Referring to FIG. 10, in operation 1010, an electronic device (e.g., the terminal device 101 of FIG. 1) may detect that a user purchases an object in a space corresponding to the position of the user. In response to detecting the purchase of the object, the electronic device may exclude an interaction for the purchased object from an interaction history. For example, in response to detecting the purchase of the object, the electronic device deletes a record of the interaction between the user and a corresponding object from the interaction history. The electronic device may update the interaction history by deleting, from the interaction history, the record of the interaction for the object for which the purchase is detected.

In operation 1020, the electronic device may reselect a piece of content on the detected object, based on the interaction history from which the interaction for the purchased object is excluded.

According to an embodiment, the electronic device may select the piece of content on the detected object, based on the interaction between the detected object and the user.

For example, when detecting that the user purchases the detected object, the electronic device may exclude the interaction between the user and the object detected from the interaction history. The electronic device may reselect the piece of content on the detected object. For example, the electronic device predicts, based on the interaction history from which the interaction for the detected object is excluded, the interaction level for the detected object as interaction level 0. Alternatively, the electronic device may predict, based on the interaction history from which the interaction for the detected object is excluded, that the interaction between the user and the detected object is not to be detected.

For example, when detecting that the user purchases another object, the electronic device skips reselecting the piece of content on the detected object. Alternatively, when detecting that the user purchases another object, the electronic device may select the same piece of content, even when the electronic device reselects the piece of content on the detected object, based on the interaction history from which the interaction of another object is excluded.

According to an embodiment, the electronic device may select the piece of content on the detected object, based on the interaction between the user and another object related to the detected object together with the interaction between the user and the detected object.

For example, when detecting that the user purchases the detected object, the electronic device excludes the interaction between the user and the object detected from the interaction history. The electronic device may select the piece of content on the detected object, based on the interaction history from which the interaction for the detected object is excluded. For example, the electronic device predicts the interaction level for the detected object, based on the interaction history from which the interaction for the detected object is excluded. The electronic device may reselect the piece of content on the detected object, based on the record of the interaction between the user and another object related to the detected object included in the interaction history.

For example, when detecting that the user purchases another object related to the detected object, the electronic device excludes, from the interaction history, the interaction between the user and another object for which the purchase is detected. The electronic device may reselect the piece of content on the detected object, based on the interaction history from which the interaction for another object for which the purchase is detected is excluded.

For example, when detecting that the user purchases an object unrelated to the detected object, the electronic device skips reselecting the piece of content on the detected object. Alternatively, when detecting that the user purchases the object unrelated to the detected object, the electronic device may select the same piece of content, even when the electronic device reselects the piece of content on the detected object, based on the interaction history from which the interaction of the object unrelated to the detected object is excluded. As described above, the object unrelated to the detected object is, for example, an object not related to the detected object, wherein the object is different from the detected object and another object related to the detected object.

Although not explicitly shown in FIG. 10, the electronic device may instruct the AR device to display the piece of content on the detected object mapped to an interaction level that is predicted again.

According to an embodiment, an terminal device 101 may include memory 130 storing computer-executable instructions and a processor for executing the instructions by accessing the memory 130.

The instructions may be configured to detect an object in an image received from an AR device 200.

The instructions may be configured to obtain, based on the identifier of the user and the position of the user received from the AR device 200, an interaction history for the interaction between the user and the detected object to obtain information about the detected object.

The instructions may be configured to instruct, based on the obtained interaction history, the AR device 200 to display a piece of content selected from a plurality of pieces of content on the object.

The interaction between the user and the object may include one or a combination of two or more of an action of the user gazing at the object or a predetermined portion of the object, an action of the user touching the object with a portion of the body of the user, or an action of the user generating an input for requesting additional information about the object.

The instructions may be configured to predict the level of the interaction between the object and the user, based on the interaction between the user and the object in the obtained interaction history.

The instructions may be configured to instruct the AR device to display a piece of content mapped to the predicted level among the plurality of pieces of content on the object mapped to a plurality of interaction levels.

The instructions may be configured to select, from the obtained interaction history, a piece of content on the object, based on the interaction between the user and another object related to the object together with the interaction between the user and the object.

The instructions may be configured to calculate an interaction score for the object using a weight assigned to the level of the interaction between the user and the object for the interaction between the user and the object in the obtained interaction history.

The instructions may be configured to select the piece of content on the object, based on the calculated interaction score.

The instructions may be configured to calculate the interaction score for the object using a weight less than a weight assigned to the level of the interaction between the user and another object, with respect to the interaction between the user and another object related to the object in the obtained interaction history.

The instructions may be configured to select the piece of content on the object, based on the calculated interaction score.

The instructions may be configured to obtain an interaction history for the interaction between the user and the object in another space related to the space together with the interaction between the user and the object in the space.

The instructions may be configured to, in response to detecting a plurality of objects in the image, select a piece of content on each of the plurality of objects.

The instructions may be configured to instruct the AR device 200 to display a piece of content selected for a corresponding object for each of the plurality of objects.

The instructions may be configured to instruct the AR device 200 to display the piece of content on the object on a region determined based on display information including a position on which the object is displayed in the space.

The instructions may be configured to, in response to detecting a new interaction between the user and the object in the space, update the interaction history based on the detected new interaction.

The instructions may be configured to reselect the piece of content on the object, based on the updated interaction history.

The instructions may be configured to, in response to detecting the purchase of the object, exclude the interaction for the purchased object from the interaction history.

The instructions may be configured to reselect the piece of content on the object, based on the interaction history from which the interaction for the purchased object is excluded.

According to an embodiment, a method performed by an terminal device 101 may include detecting an object in an image received from an AR device 200.

According to an embodiment, the method performed by the terminal device 101 may include obtaining, based on the received identifier of the user and a position of the user, an interaction history for the interaction between the user and the detected object to obtain information about the object.

According to an embodiment, the method performed by the terminal device 101 may include instructing, based on the obtained interaction history, the AR device 200 to display a selected piece of content from among a plurality of pieces of content on the object.

The interaction between the user and the object may include one or a combination of two or more of an action of the user gazing at the object or a predetermined portion of the object, an action of the user touching the object with a portion of the body of the user, or an action of the user generating an input for requesting additional information about the object.

The instructing of the AR device 200 to display the selected piece of content may include predicting, based on the interaction between the object and the user in the obtained interaction history, the level of the interaction between the object and the user.

The instructing of the AR device 200 to display the selected piece of content may include instructing the AR device 200 to display a piece of content mapped to the predicted level among the plurality of pieces of content on the object mapped to a plurality of interaction levels.

The instructing of the AR device 200 to display the selected piece of content may include selecting the piece of content on the object, based on the interaction between the user and another object related to the object together with the interaction between the user and the object in the obtained interaction history.

The instructing of the AR device 200 to display the selected piece of content may include, with respect to the interaction between the user and the object in the obtained interaction history, calculating an interaction score for the object using a weight assigned to the level of the interaction between the user and the object.

The instructing of the AR device 200 to display the selected piece of content may include selecting the piece of content on the object, based on the calculated interaction score.

The instructing of the AR device 200 to display the selected piece of content may include, with respect to the interaction between the user and another object related to the object in the obtained interaction history, calculating the interaction score for the object using a weight less than a weight assigned to the level of the interaction between the user and another object.

The instructing of the AR device 200 to display the selected piece of content may include selecting the piece of content on the object, based on the calculated interaction score.

The obtaining of the interaction history may include obtaining an interaction history for the interaction between the user and the object in another space related to the space together with the interaction between the user and the object in the space.

According to an embodiment, a method performed by an terminal device 101 may include, in response to detecting a new interaction between the user and the object in the space, updating the interaction history based on the detected new interaction.

According to an embodiment, the method performed by the terminal device 101 may include reselecting the piece of content on the object, based on the updated interaction history.

According to an embodiment, the method performed by the terminal device 101 may include, in response to detecting that the object is purchased, excluding an interaction for the purchased object from the interaction history.

According to an embodiment, the method performed by the terminal device 101 may include reselecting the piece of content on the object, based on the interaction history from which the interaction for the purchased object is excluded.

The electronic device according to an embodiment disclosed herein may be one of various types of electronic devices. The electronic devices includes, for example, a portable communication device (e.g., a smartphone), a computer device, a portable multimedia device, a portable medical device, a camera, a wearable device, or a home appliance. According to an embodiment of the disclosure, the electronic device is not limited to those described above.

It should be appreciated that embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, “A or B,” “at least one of A and B,” “at least one of A or B,” “A, B or C,” “at least one of A, B and C,” and “at least one of A, B, or C,” may include any one of the items listed together in the corresponding one of the phrases, or all possible combinations thereof. Terms such as “1st” and “2nd,” or “first” and “second” may be used to simply distinguish a corresponding component from other components, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., by wire), wirelessly, or via a third element.

As used in connection with embodiments of the disclosure, the term “module” may include a unit implemented in hardware, software, or firmware, and may interchangeably be used with other terms, for example, “logic”, “logic block”, “part”, or “circuitry”. A module may be a single integral component, or a minimum unit or part thereof, adapted to perform one or more functions. For example, according to an embodiment, the module is implemented in a form of an application-specific integrated circuit (ASIC). This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to embodiments of the disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to embodiments, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
memory storing one or more computer programs; and
one or more processors communicatively coupled to the memory,
wherein the one or more computer programs include computer-executable instructions that, when executed by the one or more processors individually or collectively, cause the electronic device to:
detect an object in an image received from an augmented reality (AR) device,
obtain, based on an identifier of a user and a position of the user received from the AR device, an interaction history for an interaction between the user and the detected object to obtain information about the detected object, and
instruct, based on the obtained interaction history, the AR device to display a piece of content selected from among a plurality of pieces of content.

2. The electronic device of claim 1, wherein the interaction between the user and the object comprises at least one or a combination of two or more of an action of the user gazing at the object or a predetermined portion of the object, an action of the user touching the object with a portion of a body of the user, or an action of the user generating an input for requesting additional information about the object.

3. The electronic device of claim 2, wherein the one or more computer programs further include computer-executable instructions that, when executed by the one or more processors individually or collectively, cause the electronic device to:
predict, based on the interaction between the object and the user in the obtained interaction history, a level of the interaction between the object and the user, and
instruct the AR device to display a piece of content mapped to the predicted level among a plurality of pieces of content on the object mapped to a plurality of interaction levels.

4. The electronic device of claim 3, wherein the one or more computer programs further include computer-executable instructions that, when executed by the one or more processors individually or collectively, cause the electronic device to select a piece of content on the object, based on an interaction between the user and another object related to the object together with the interaction between the user and the object in the obtained interaction history.

5. The electronic device of claim 4, wherein the one or more computer programs further include computer-executable instructions that, when executed by the one or more processors individually or collectively, cause the electronic device to, with respect to the interaction between the user and the object in the obtained interaction history, calculate an interaction score for the object using a weight assigned to a level of the interaction between the user and the object and select a piece of content on the object, based on the calculated interaction score.

6. The electronic device of claim 5, wherein the one or more computer programs further include computer-executable instructions that, when executed by the one or more processors individually or collectively, cause the electronic device to:
with respect to the interaction between the user and another object related to the object in the obtained interaction history, calculate an interaction score for the object using a weight less than a weight assigned to a level of the interaction between the user and the other object, and
select the piece of content on the object, based on the calculated interaction score.

7. The electronic device of claim 6, wherein the one or more computer programs further include computer-executable instructions that, when executed by the one or more processors individually or collectively, cause the electronic device to obtain an interaction history for an interaction between the user and an object in another space related to a space together with an interaction between the object and the user in the space.

8. The electronic device of claim 7, wherein the one or more computer programs further include computer-executable instructions that, when executed by the one or more processors individually or collectively, cause the electronic device to:
in response to detecting a plurality of objects in the image, select a piece of content on each of the plurality of objects, and
instruct the AR device to display the selected piece of content on a corresponding object for each of the plurality of objects.

9. The electronic device of claim 8, wherein the one or more computer programs further include computer-executable instructions that, when executed by the one or more processors individually or collectively, cause the electronic device to instruct the AR device to display the piece of content on an object on a region determined based on display information comprising a position on which the object is displayed in the space.

10. The electronic device of claim 9, wherein the one or more computer programs further include computer-executable instructions that, when executed by the one or more processors individually or collectively, cause the electronic device to:
in response to detecting a new interaction between the user and the object in the space, update the interaction history based on the detected new interaction, and
reselect the piece of content on the object based on the updated interaction history.

11. The electronic device of claim 10, wherein the one or more computer programs further include computer-executable instructions that, when executed by the one or more processors individually or collectively, cause the electronic device to:
in response to detecting that an object is purchased, exclude the interaction for the purchased object from the interaction history, and
reselect a piece of content on the object, based on the interaction history from which the interaction for the purchased object is excluded.

12. A method performed by an electronic device, the method comprising:
detecting, by the electronic device, an object in an image received from an augmented reality (AR) device;
obtaining, by the electronic device, based on an identifier of a user and a position of the user received from the AR device, an interaction history for an interaction between the user and the detected object to obtain information about the detected object; and
instructing, by the electronic device, based on the obtained interaction history, the AR device to display a piece of content selected from among a plurality of pieces of content on the object.

13. The method of claim 12, wherein the interaction between the user and the object comprises one or a combination of two or more of an action of the user gazing at the object or a predetermined portion of the object, an action of the user touching the object with a portion of a body of the user, or an action of the user generating an input for requesting additional information about the object.

14. The method of claim 13, wherein the instructing of the AR device to display the selected piece of content comprises:
predicting, based on the interaction between the object and the user in the obtained interaction history, a level of the interaction between the object and the user; and
instructing the AR device to display a piece of content mapped to the predicted level among a plurality of pieces of content on the object mapped to a plurality of interaction levels.

15. The method of claim 14, further comprising:
selecting a piece of content on the object, based on an interaction between the user and another object related to the object together with the interaction between the user and the object in the obtained interaction history.

16. The method of claim 15, further comprising:
with respect to the interaction between the user and the object in the obtained interaction history, calculating an interaction score for the object using a weight assigned to a level of the interaction between the user and the object and select a piece of content on the object, based on the calculated interaction score.

17. The method of claim 16, further comprising:
with respect to the interaction between the user and the object in the obtained interaction history, calculating an interaction score for the object using a weight assigned to a level of the interaction between the user and the object and select a piece of content on the object, based on the calculated interaction score.

18. The method of claim 17, further comprising:
with respect to the interaction between the user and another object related to the object in the obtained interaction history, calculating an interaction score for the object using a weight less than a weight assigned to a level of the interaction between the user and the other object; and
selecting the piece of content on the object, based on the calculated interaction score.

19. One or more non-transitory computer-readable storage media storing one or more computer programs including computer-executable instructions that, when executed by one or more processors of an electronic device individually or collectively, cause the electronic device to perform operations, the operations comprising:
detecting, by the electronic device, an object in an image received from an augmented reality (AR) device;
obtaining, by the electronic device, based on an identifier of a user and a position of the user received from the AR device, an interaction history for an interaction between the user and the detected object to obtain information about the detected object; and
instructing, by the electronic device, based on the obtained interaction history, the AR device to display a piece of content selected from among a plurality of pieces of content on the object.

20. The one or more non-transitory computer-readable storage media of claim 19, wherein the interaction between the user and the object comprises one or a combination of two or more of an action of the user gazing at the object or a predetermined portion of the object, an action of the user touching the object with a portion of a body of the user, or an action of the user generating an input for requesting additional information about the object.
